(19) United States
(12) Patent Application Publication
(10) Pub. No.: US 2015/0206451 A1
(43) Pub. Date: Jul. 23, 2015

(54) METHOD AND SYSTEM FOR PROVISIONING COMPUTING DEVICES BASED ON HEALTH CONDITION

(71) Applicant: OpenPeak Inc., Boca Raton, FL (US)

(72) Inventor: Charles Peter Schultz, North Miami Beach, FL (US)

(21) Appl. No.: 14/581,084

(22) Filed: Dec. 23, 2014

Related U.S. Application Data
(60) Provisional application No. 61/920,977, filed on Dec. 26, 2013.

(51) Int. Cl. G09B 19/00; H04L 29/08

(52) U.S. Cl. CPC G09B 19/0092; H04L 67/10

(57) ABSTRACT

A method of provisioning a computing device based on a health condition of a user is described herein. The method can include the steps of receiving health information from the user in which the health information is related to the health condition of the user and automatically generating health content that is based on the health information from the user. The health content can be delivered to the computing device of the user, and the progress of the user can be monitored with respect to the health condition of the user. The user's progress may be at least partly based on the user's use of the health content. Based on the monitoring of the progress of the user, the health content can be automatically dynamically managed to account for changes or lack of changes in the health condition of the user.

### CROSS-REFERENCE TO RELATED APPLICATIONS

This patent application claims priority to U.S. provisional patent application No. 61/920,977, filed on Dec. 26, 2013, which is incorporated herein by reference in its entirety.

### FIELD OF TECHNOLOGY

The present description relates to methods and systems for the provisioning of computing devices and more particularly, the provisioning of such devices based on certain conditions.

### BACKGROUND

Many consumers own mobile devices that may download and install a wide variety of applications, or apps. In fact, some mobile platforms provide electronic storefronts, or app stores, that offer hundreds of thousands of applications for the consuming public. In view of the overwhelming number of applications that are made available, users of the mobile devices may have a difficult time in finding applications that are suitable for them.

### SUMMARY

A method of provisioning a computing device based on a health condition of a user is described herein. In particular, health information can be received from the user in which the health information is related to the health condition of the user. Health content that is based on the health information from the user can be automatically generated and delivered to the computing device of the user. The progress of the user can be monitored with respect to the health condition of the user in which the progress of the user is at least partly based on the user's use of the health content. Based on the monitoring of the progress of the user, the health content can be automatically dynamically managed to account for changes or lack of changes in the health condition of the user.

Rewards may also be provided to the user based on the monitoring of the progress of the user, such as towards a personal or assigned health goal. As an example, the rewards may include a credit for a retail establishment, a credit for a treatment facility, or the delivery of free or reduced-fee content to the user's computing device.

In one arrangement, the health content includes one or more treatment applications that are designed to improve the user's health condition or one or more configurations to be applied to the computing device to improve the user's health condition. In another arrangement, dynamically managing the health content may include delivering additional treatment applications, remotely deleting treatment applications from the computing device that have been deemed to be inappropriate or adjusting the configurations to be applied to the computing device.

A method of treating a health condition of a user of a computing device is also described herein. Health information can be received from the user in which the health information is related to the health condition of the user, and health content can be delivered to the computing device of the user in which the health content is based on the health information received from the user. The progress of the user can be monitored with respect to the health condition of the user, and based on the monitoring of the progress of the user, the health content can be automatically dynamically managed to account for changes or lack of changes in the health condition of the user.

Another method of provisioning a computing device based on a health condition of a user is described herein. In particular, a user can provide health information through a computing device, and the health information is related to the health condition of the user. In response, the computing device can be automatically provisioned with health content that is based on the health information from the user. The user can provide updated health information that is related to the health condition through the computing device to enable the user's progress to be monitored. In response, the health content on the user's computing device can be automatically dynamically managed to account for changes or lack of changes in the health condition of the user. Moreover, the user can be provided with rewards based on the progress that the user shows during this process.

As an example, the health information can be a previously-known diagnosis of the health condition of the user. As another example, the health content can be a content bundle that includes one or more applications and data that explain the causes of the health condition of the user and present one or more treatment regimens for the health condition. In yet another example, the health content includes one or more settings that are to be applied to the computing device of the user that are designed to improve the user's health condition.

Severity grades may also be assigned to the health condition in which the severity grade determines a level of review of the health content to be delivered to the computing device. In another arrangement, automatically dynamically managing the health content can include delivering to the computing device additional treatment applications or replacing existing treatment applications with updated treatment applications. Also, automatically dynamically managing the health content can include adjusting the settings that have been applied to the computing device. As mentioned previously, rewards can be provided to the user based on his or her progress. As another example, a reward repository can be presented to the user to enable the user to select one or more rewards from the reward repository based on the user's progress is reaching one or more health goals.

A system for provisioning a computing device based on a health condition of a user is also described herein. The system can include an interface that can be configured to receive health information from the user in which the health information may be related to the health condition of the user. The system can also include a health analysis engine that can be configured to analyze the received health information and generate health content that is based on the health information received from the user. The interface may be further configured to deliver the health content to the computing device of the user. Additionally, the health analysis engine can be further configured to dynamically manage the health content to account for changes or lack of changes in the health condition of the user based on a monitoring of the progress of the health condition of the user. The health analysis engine (or health analysis processor) can include any suitable combination of software and hardware components.

As an example, the user's progress can be at least partly based on the user's use of the health content. As another example, the health analysis engine can be further configured to determine rewards to be provided to the user based on the monitoring of the progress of the user. For example, the rewards in the system can include a credit for a retail establishment, a credit for a treatment facility, or the delivery of free or reduced-fee content to the user's computing device.

In one arrangement, the health content can include one or more treatment applications that may be designed to improve the user's health condition or one or more configurations to be applied to the computing device to improve the user's health condition. In another arrangement, the health analysis engine can be configured to dynamically manage the health content by causing the delivery of additional treatment applications to the computing device of the user, by causing the remote deletion of treatment applications from the computing device that have been deemed to be inappropriate or by causing the adjustment of the configurations to be applied to the computing device. The system can also include an encryption engine that that can be configured to encrypt or decrypt the health information of the user and the health content for the user.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for provisioning a computing device based on a health condition of a user.

FIG. 2 illustrates an example of a management platform of the system of FIG. 1.

FIG. 3 illustrates an example of a method for provisioning a computing device based on a health condition of a user.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described. The term “among,” as it is used throughout this description, should not necessarily be interpreted as requiring exchanges or interaction among three or more applications, irrespective of grammar rules.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged (directly or indirectly) between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The term “non-transitory computer readable storage medium” is defined as one or more non-transitory components that are configured to store instructions that are to be executed by one or more processing units.

An “application” is defined as a program or programs that perform one or more particular tasks on a computing device. Examples of an application include programs that may present a user interface for interaction with a user or that may run in the background of an operating environment that may not present a user interface while in the background. The term “operating system” is defined as a collection of software components that directs a computing device's operations, including controlling and scheduling the execution of other programs and managing storage, input/output and communication resources. A “processing unit” is defined as one or more components that execute sets of instructions, and the components may be disparate parts or part of a whole unit and may not necessarily be located in the same physical location. The term “memory” or “memory element” is defined as one or more components that are configured to store data, either on a temporary or persistent basis. The term “shared memory” is memory or a memory element that is accessible (directly or indirectly) by two or more applications or other processes. An “interface” is defined as a component or a group of components that enable(s) a device to communicate with one or more different devices, whether through hard-wired connections, wireless connections or a combination of both. The term “file system” is defined as an abstraction that is used to organize, store and retrieve data. A “health analysis engine” or “health analysis processor” is defined as one or more components that are configured to execute instructions to enable analysis of information related to the health of one or more persons or animals.

The term “health condition” is defined as a condition, affliction or state or measurement of such that affects a person's health in some abnormal way. The term “health information” is defined as information that is related to a person's health condition and that is analyzed to prepare or generate material that may be used to treat, control or monitor the person's health condition. The term “health content” is defined as content that may be used by a person or another to assist in treating, controlling or monitoring the person's health condition. The term “dynamically managing the health content” or “dynamically manage the health content” is defined as a process by which a person's health condition or the person's use of health content (or both) is monitored and corresponding adjustments are made to the health content to account for changes or lack of changes in the person's health condition or based on usage of the health content (or both). A “reward” is defined as some object, service or remuneration given or offered to a user.

As explained earlier, there are thousands of applications available for download to a user's mobile device. In view of the staggering amount of choices, it may be difficult for the user to find suitable applications. This vexing issue may be magnified when dealing with applications that are health-related, as a less-than-optimal application may negatively affect a user's health.

To overcome this problem, a method and system of provisioning a computing device based on a health condition of a user is presented herein. The method can include the steps of receiving health information from the user in which the health information is related to the health condition of the user and automatically generating health content that is based on the health information from the user. The health content can be delivered to the computing device of the user, and the progress of the user can be monitored with respect to the health condition of the user. The user's progress may be at least partly based on the user's use of the health content. Based on the monitoring of the progress of the user, the health content can be automatically dynamically managed to account for changes or lack of changes in the health condition of the user.

As such, appropriate health-related applications or other content may be identified and delivered to a user. The progress of the user may be monitored, and the type and number of health-related applications or other content may be adjusted based on the monitoring. In addition, to encourage the user's participation, rewards may be granted to the user, based on the user's progress, the user's use of the delivered health content, or both.

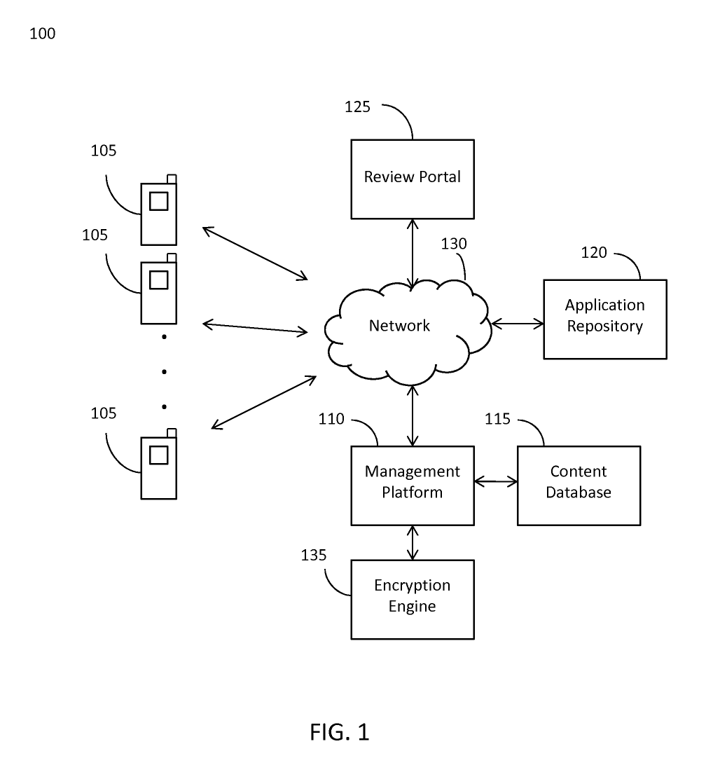

Referring to FIG. 1, an example of a system 100 for provisioning one or more computing devices 105 based on a health condition of a user is shown. In addition to the computing devices 105, the system 100 can include one or more management platforms 110, one or more content databases 115, one or more application repositories 120, one or more review portals 125, one or more networks 130 and one or more encryption engines 135. The management platform 110 may provide numerous services for managing a plurality of the computing devices 105. Earlier presentations have been provided that illustrate a solution that describes some of these services, such as in U.S. Pat. No. 8,615,581, issued on Dec. 24, 2011 and U.S. Pat. No. 8,695,060, issued on Apr. 8, 2014, each of which is incorporated by reference herein in its entirety. In one particular example, the management platform 110 may be responsible for delivering certain content to and configuring certain settings of the computing devices 105.

The content database 115 can be any suitable non-transitory storage medium that can store content that the management platform 110 can access for delivery to the computing devices 105. The content database 115 may be part of the management platform 110 or can be located remotely as a separate component or facility. In either arrangement, the management platform 110 can be communicatively coupled to the content database 115, including through the network 130, even though such a configuration is not necessarily pictured here.

As an example, the application repository 120 can be a repository that stores and offers multiple applications and other content for download to the computing devices 105. As part of this offering, the application repository 120 can present an electronic storefront that enables the download of such applications and content. In addition, the application repository 120 may be open to the general public, or its use may be restricted to only authorized personnel. In one particular arrangement, an enterprise or organization may be responsible for operating or controlling the application repository 120, and only computing devices 105 associated with the enterprise or organization may access the application repository 120. The management platform 110 may be configured to retrieve applications and other content from the application repository 120, which may be stored in the content database 115 or delivered directly to the computing devices 105. Further, the management platform 110 may also direct the computing devices 105 to retrieve such applications or content directly from the application repository 120.

In one arrangement, the review portal 125 may be established and configured to enable a review of the content to be delivered to the computing devices 105. This review may ensure that the content for the computing devices 105 is appropriate for whatever circumstances that have warranted the delivery of the content to the devices 105. The review of the content can be conducted by one or more individuals who may be trained in an area that is related to the content. In addition to or in lieu of the review by the individuals, an automated review may be conducted that relies on one or more programs to review the content that has been selected for delivery to the computing devices 105. As another option, the review portal 125 may be part of the management platform 110 or may be remotely located from the management platform 110 yet under the control of the management platform 110. In another example, the review portal 125 may be under the control of an entity that is independent of any entity that operates the management platform 110.

The network 130 may be any suitable type and number of components for facilitating communications between the various components of the system 100. As an example, the network 130 may be composed of various types of components to support wireless or wired communications (including both) and may be configured to support both local or wide area communications (or both). The encryption engine 135 can encrypt and decrypt the health information received from the user and the health content to be delivered to the user. This component may be useful because the system 100 is involved in the receipt, analysis and delivery of potentially sensitive medical information.

As an example, the management platform 110, the content database 115, the application repository 120 and/or the review portal 125 may be controlled or managed by any number of various entities, some of which may be involved in the medical industry. In addition, as mentioned earlier, there may be multiple instances of one or more of these components of the system 100, and they may be under the control of several different entities. For example, a health insurance company may control the management platform 110, the content database 115 and the application repository 120, while a pharmaceutical company, hospital or government agency may control the review portal 125. Moreover, any number of entities may be permitted to provide applications, programs, information or other data that may be uploaded to the application repository 120 and the content database 115. In addition, some other entity may be responsible for reviewing this material prior to its delivery to the repository 120 or the database 115.

Although a more detailed discussion will be presented below, a brief exemplary explanation of the system 100 will be illustrated here. In particular, a user of a computing device 105 may be experiencing some form of a health condition, such as a disease or other health abnormality. Through the computing device 105, the user may provide health information related to the health condition, and this information may be sent to the management platform 110. The management platform 110 may analyze this information, and may retrieve from the content database 115 and/or the application repository 120 some form of health content that may be useful for treating or monitoring the health condition. In one case, the application repository 120 can be configured as a specialty health-related electronic storefront (health shop) that provides content that is particularly geared towards healthcare. As an option, prior to delivery, the review portal 125 can review the health information and the retrieved health content to ensure the appropriateness of the health content. Eventually, the health content may be delivered to the relevant computing device 105.

Over time, the progress of the user can be monitored with respect to the health condition of the user. Based on this monitoring, the management platform 110 can dynamically manage the health content to account for changes or lack of changes in the health condition of the user. Examples of the process of dynamically managing the health content will be illustrated below.

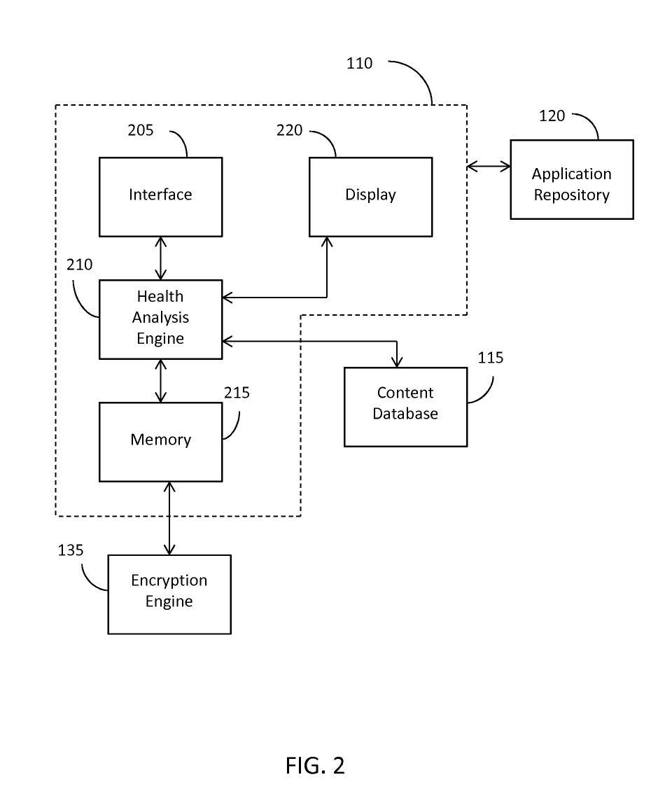

Referring to FIG. 2, an example of a block diagram of the management platform 110 is shown. In this example, the management platform 110 can include one or more interfaces 205, one or more health analysis engines 210, memory 215 and one or more displays 220. The interface 205 can be configured to, for example, receive health information from a user of a computing device 105 (see FIG. 1) and can forward the information to the health analysis engine 210. As an example, the interface 205 can be comprised of any suitable number and type of components to enable wired or wireless (or both) signal exchange with the network 130 (see FIG. 1) or some other suitable device. In fact, in one particular arrangement, the interface 205 can be an array of components that enable wireless or wired transmission/receipt over various networks or with different devices that operate in accordance with any number of wireless or wired standards or protocols.

The health analysis engine 210 can be configured to analyze the health information that is received from the user of the computing device 105 and can generate health content that is based on the health information. The term “generate” or “generating” is defined as producing, retrieving, accessing, constructing or creating such that health content can be organically created by the health analysis engine 210 or can be retrieved by the health analysis engine 210 from some other source or a combination of the two. The analysis that is performed by the health analysis engine 210 may be performed automatically, with input from one or more persons, inputs from instruments or any combination thereof. Based on the analysis, the engine 210 can, for example, retrieve health content from the content database 115 or from some other source, such as the application repository 120. The memory 215 can store various programs and other data to enable the operation of the health analysis engine 110, and the display 220 can display information to one or more users of the engine 110.

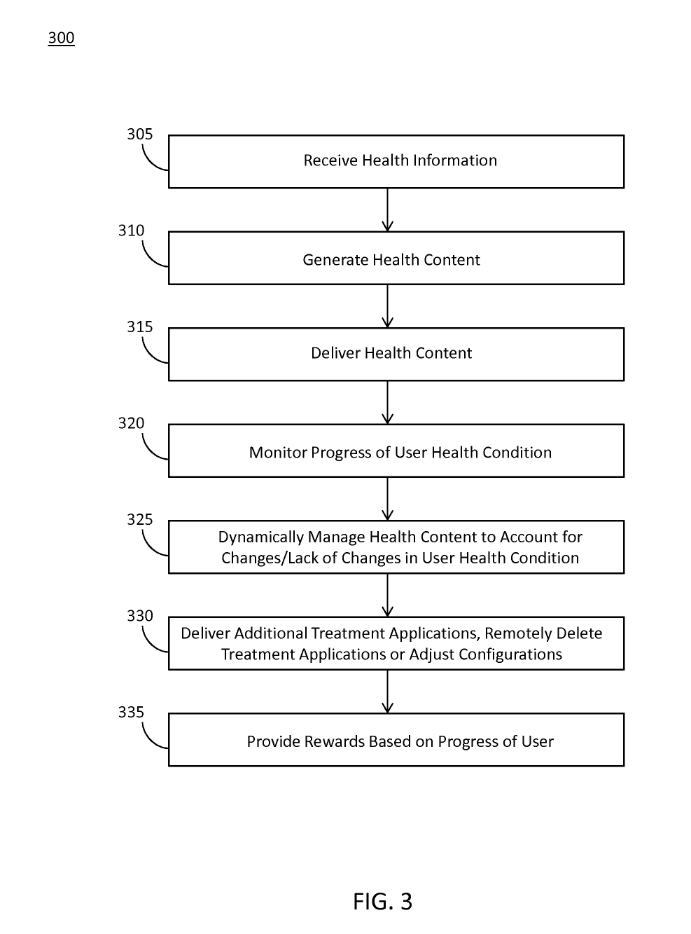

Referring to FIG. 3, an exemplary method 300 for provisioning a computing device based on a health condition of a user is illustrated. It is important to note, however, that the method 300 may include additional or even fewer steps or processes in comparison to what is illustrated in FIG. 3. Moreover, the method 300 is not necessarily limited to the chronological order that is shown in FIG. 3. In describing the method 300, reference may be made to FIGS. 1-2, although it is understood that the method 300 may be practiced with any other suitable systems and components and may take advantage of other suitable processes.

At step 305, health information can be received from a user of a computing device, and at step 310, health content that is based on the health information from the user can be generated. In addition, the health content can be delivered to the computing device of the user, as shown at step 315.

For example, a user of a computing device 105 may be suffering from a health condition, either physical or mental ailments or both. A client that is installed on the computing device 105 or some other program may enable the user to provide health information through the computing device 105 or some other suitable portal. For example, the user may provide information related to their condition by answering a series of questions or by entering key terms into an appropriate space. As another example, the user may create video or audio recordings (or both) that explain the issues related to their ailment(s). In certain cases, the user may be unaware of the cause of his/her health condition or its diagnosis. Alternatively, the user may already be aware of what is causing his/her health condition, and the user can simply enter the already-known diagnosis into the computing device 105. In either scenario, the health information that the user supplies can be sent to the management platform 110.

Once received at the management platform 110, the health analysis engine 210 can be configured to perform an analysis of the health information. For example, the health analysis engine 210 can automatically review the health information and can generate health content that may be useful for explaining, treating, controlling or otherwise dealing with the health condition. In one particular example, content bundles that are designed specifically for certain ailments or conditions may be produced and stored in, for example, the content database 115. For example, a content bundle may be created for obesity, and the bundle may include applications and data that may explain the causes of the condition and can present one or more treatment regimens, which may be designed to improve the user's health condition. In this example, the user may provide health information, such as height and weight, through the computing device 105 and the health analysis engine 210 may be configured to perform a body mass index (BMI) calculation to determine whether the user is suffering from obesity. As another example, the user may provide additional measurements (if known), such as blood pressure, blood chemistry, and resting heart rate, which may also be part of the analysis. In response, the engine 210 can be further configured to retrieve the content bundle that has been previously prepared for this condition and can cause the content bundle to be delivered to the user's computing device 105.

Users that suffer from multiple health conditions may receive a plurality of bundles, with each one designed to treat a particular ailment from which the user is suffering. These bundles may, in certain case, contain uniform content such that users with similar health conditions and health profiles may be treated in a comparable fashion. Of course, given the nuances involved with treating different humans with various health conditions, the bundles may be provided with certain customizations that are based on the particular user involved.

The health content may also include one or more settings that may be applied to the computing device 105, which may also be designed to improve the user's health condition. For example, certain features of the device 105 may be activated or deactivated in view of the particular health condition. As a specific example, if a user is suffering from insomnia, settings may be applied to the device 105, as part of the health content, that cause the display to move to a low brightness level and that disable certain audio features, like text alerts, after a certain hour.

Although these processes were described as being performed automatically, it can also be done by or at least reviewed by one or more persons, such as individuals who are trained medical professionals. For example, considering the obesity case described above, one or more medical professionals may review the analysis performed by the health analysis engine 210 and the selected health content to ensure the accuracy of the analysis and selection. In another example, a severity scale can be implemented such that health conditions can be assigned severity grades. Those health conditions that are given higher severity grades may warrant additional layers of review or the generated health content that is associated with these health conditions may not be distributed without a review. In contrast, a review may not be necessary for health conditions that are deemed not as severe, or at least an abridged review may be conducted.

As noted earlier, the health content may be retrieved from the content database 115. The health analysis engine 210, however, may retrieve the health content from other suitable sources. For example, the engine 210 can retrieve one or more applications from the application repository 120. As another example, the delivery of the health content may simply involve sending one or more links or other similar objects to the user's computing device 105 to enable the user to retrieve the health content through the user's device 105.

Once delivered, the user suffering from the health condition may review the health content and can follow a treatment regimen or some other similar procedure or process established by the health content, if one has been provided. For example, in the obesity case, the user, after reviewing the health content, may learn that he/she is obese and may wish to follow the prescribed treatment plan that is provided with the health content. In particular, one or more weight-control applications, which have been downloaded on the computing device 105, may provide to the user a dieting or food control plan over the course of some time period, while others may present several exercise programs for the user. Some of these applications may enable the user to perform caloric calculations, while others may include information related to weight control and some of the negative consequences of obesity. Of course, the foregoing examples are not meant to be limiting, as other types of health content may be delivered to and used by the user.

Referring back to FIG. 3, at step 320, the progress of the user may be monitored with respect to the health condition of the user, and at least part of the progress may be based on the user's use of the health content. At step 325, based on the monitoring of the progress of the user, the health content can be automatically dynamically managed to account for changes or lack of changes in the health condition of the user. Examples of dynamically managing the health content include delivering additional treatment applications to the computing device, remotely deleting from the computing device treatment applications that have been deemed inappropriate or adjusting configurations to be applied to the computing device, which are shown in step 330. At step 335, rewards may be provided to the user based on the monitoring of the progress of the user.

As an example, the user may provide updated health information related to the health condition of the user. This information may be entered through the health content that was delivered to the computing device 105, such as through one or more applications, or through the medium that was used to accept the original health information. The user may provide the updates to the health information through menu selections, answers to questionnaires or updated audio and/or video recordings. The updates may be scheduled based on some predetermined time frame or may be even random in nature. The updated health information can be collected at the computing device 105 or sent directly to the management platform 110 or some other component.

Once received at the management platform 110, the health analysis engine 210 may monitor the progress of the user with respect to the user's health condition, such as by performing additional analyses on the updated health information, similar to the process described above. In addition, as part of this monitoring, the health analysis engine 210 may analyze the user's use of the delivered health content. For example, considering the obesity scenario, the user may provide updated health information in the form of current weight, blood pressure, resting heart rate, etc, all or a portion of which may be used by the engine 210 during its analysis. The health analysis engine 210 may also determine which health content the user has been consuming and which content has been ignored or seldom used.

As part of its analysis, the health analysis engine 210 may determine that the user is making satisfactory progress or is not meeting certain predefined goals or other criteria. In the obesity example, in analyzing the updated health information, the engine 210 may determine that the user's weight loss has not met a certain threshold for a predetermined time period or that the user's blood pressure remains too high. In addition, the engine 210 may determine that the user has ignored one or more applications that provide high-impact exercise programs.

Based on the monitoring of the progress of the user's health condition, the health analysis engine 210 (or some other component) may automatically dynamically manage the health content to account for changes or lack of changes in the health condition of the user. For example, another bundle may be delivered to the user's computing device 105 that may include additional applications or modified settings to be applied to the device 105. As another example, certain applications may be remotely deleted from the device 105, if it is determined that these applications are now deemed inappropriate. These deleted applications may or may not be replaced with other suitable applications. If replaced, the new applications may be part of updates or changes to a pre-existing bundle. In addition, certain settings or configurations of the computing device 105 may be adjusted—including activated or deactivated. Changes in the health condition may include transitions to better or worse health for the user over the relevant time period, while lack of changes in the health condition may include little or no improvement or a slight degradation in the user's condition.

Consider the obesity example once again. The user's updated health information may show little or no change in the weight or BMI of the user. As noted earlier, the user may have ignored one more applications that demonstrate or call for high-impact exercises as part of a treatment regimen. In response, the health analysis engine 210 may cause one or more applications that specialize in dieting programs to be deleted from the computing device 105. As an example, these applications may be replaced with other applications that call for more intensive dieting on the part of the user. As another example, the original dieting applications may simply be updated to present updated dieting guidelines that are designed to produce a greater weight loss. In addition, the applications that focus on high-impact exercises, which were ignored by the user, may be deleted and (optionally) replaced with applications that present or specialize in low-impact exercise regimens. Certain adjustments may also be made to the settings or configurations that are applied to the computing device 105. For example, in this case, the user may be upgraded to a higher data plan to account for the receipt and use of additional exercise videos to the played on the computing device 105.

As another example, if the user has shown substantial improvement with respect to the user's health condition, the health content can be updated to account for such progress. For example, considering the obesity example, if the user loses enough weight to meet certain targets or thresholds, the dieting outlined by the health content may be relaxed, or the amount of exercise called for by the health content can be reduced. This process can include adjusting or modifying existing applications and other content or simply replacing such applications or other content.

Any adjustments to the health content to be provided to the user may be retrieved from the content database 115, the application repository 120 or some other source. Moreover, the updated health content may undergo review by the review portal prior to being released to the computing device 105, in accordance with the discussion above.

As further motivation for the user, one or more rewards may be provided to the user based on the monitoring of the user's progress. In one arrangement, the reward may include a credit for a retail establishment, a credit for a treatment facility, the delivery of free or reduced-fee content to the user's computing device 105 or any other discounts, information or content that may be used to stimulate progress. For example, based on the monitoring, the health analysis engine 210 can be configured to determine whether the user's progress has met some predetermined threshold that warrants a reward. If so, the engine 210 can cause the delivery of the reward to the user's device 105. Examples of a credit for a retail establishment include coupons or gift cards, while credits for a treatment facility may include discounts on medical office visits (like co-pays) or for gym or spa memberships or appointments. Examples of free or reduced-fee content that may be provided to the user as a reward can include treatment or therapy videos that demonstrate techniques that may be useful for treating or controlling the user's health condition. While some of these rewards may be related to the treatment of the user's health condition, the description here is not so limited. For example, the user may receive rewards that include gaming applications, music or other multi-media content, each of which may not necessarily be related to treating the user's health condition.

In another arrangement, the health analysis engine 210 or some other component may monitor the user's scheduled medical or gym appointments, and rewards may be dispensed based on the user's successful compliance with them. The rewards may be delivered directly to the user's computing device 105, or the user may retrieve the rewards from some source, like the application repository 120.

As another option, a reward repository or reward store may be integrated into the system 100 of FIG. 1, either of which may be electronic storefronts configured in a manner similar to that of the application repository 120. A user may be able to select one or more rewards from the reward repository based on that user's progress in achieving certain health goals. As another option, the reward repository may store reward or achievement bundles, which may include content that can be used to reward a user for their progress. For example, an achievement bundle may include free or discounted applications, electronic gift certificates, free or discounted multi-media materials, etc. Achievement bundles may also be stored in the content database 115, and can be retrieved and delivered by the management platform 110.

Although several examples have been presented that focus on a user participating in a health treatment plan through the user's computing device, there are several other scenarios that are contemplated by the description presented here. For example, a medical professional or family member may participate in accordance with the description herein on behalf of a patient or family member who is unable or unwilling to do so. Moreover, the description herein is not limited to humans, as it may also apply to the treatment of animals in which the owners of the animals may act as the participant on behalf of the animals.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of provisioning a computing device based on a health condition of a user, comprising:
receiving health information from the user, wherein the health information is related to the health condition of the user;
automatically generating health content that is based on the health information from the user;
delivering the health content to the computing device of the user;
monitoring the progress of the user with respect to the health condition of the user, wherein the progress of the user is at least partly based on the user's use of the health content; and
based on the monitoring of the progress of the user, automatically dynamically managing the health content to account for changes or lack of changes in the health condition of the user.

2. The method according to claim 1, further comprising providing rewards to the user based on the monitoring of the progress of the user.

3. The method according to claim 2, wherein the rewards comprise a credit for a retail establishment, a credit for a treatment facility, or the delivery of free or reduced-fee content to the user's computing device.

4. The method according to claim 1, wherein the health content includes one or more treatment applications that are designed to improve the user's health condition or one or more configurations to be applied to the computing device to improve the user's health condition.

5. The method according to claim 4, wherein dynamically managing the health content comprises delivering additional treatment applications, remotely deleting treatment applications from the computing device that have been deemed to be inappropriate or adjusting the configurations to be applied to the computing device.

6. A method of treating a health condition of a user of a computing device, comprising:
receiving health information from the user, wherein the health information is related to the health condition of the user;
delivering to the computing device of the user health content that is based on the health information received from the user;
monitoring the progress of the user with respect to the health condition of the user; and
based on the monitoring of the progress of the user, automatically dynamically managing the health content to account for changes or lack of changes in the health condition of the user.

7. The method according to claim 6, wherein the health information is a previously-known diagnosis of the health condition of the user.

8. The method according to claim 6, wherein the health content is a content bundle that includes one or more applications and data that explain the causes of the health condition of the user and present one or more treatment regimens for the health condition.

9. The method according to claim 6, wherein the health content includes one or more settings that are to be applied to the computing device of the user that are designed to improve the user's health condition.

10. The method according to claim 6, further comprising assigning a severity grade to the health condition, wherein the severity grade determines a level of review of the health content to be delivered to the computing device.

11. The method according to claim 6, wherein automatically dynamically managing the health content comprises delivering to the computing device additional treatment applications or replacing existing treatment applications with updated treatment applications.

12. The method according to claim 9, wherein automatically dynamically managing the health content comprises adjusting the settings that have been applied to the computing device.

13. The method according to claim 6, further comprising presenting a reward repository to the user to enable the user to select one or more rewards from the reward repository based on the user's progress in reaching one or more health goals.

14. A system for provisioning a computing device based on a health condition of a user, comprising:
an interface that is configured to receive health information from the user, wherein the health information is related to the health condition of the user; and
a health analysis engine that is configured to analyze the received health information and generate health content that is based on the health information received from the user;
wherein the interface is further configured to deliver the health content to the computing device of the user;
wherein the health analysis engine is further configured to dynamically manage the health content to account for changes or lack of changes in the health condition of the user based on a monitoring of the progress of the health condition of the user.

15. The system according to claim 14, wherein the user's progress is at least partly based on the user's use of the health content.

16. The system according to claim 14, wherein the health analysis engine is further configured to determine rewards to be provided to the user based on the monitoring of the progress of the user.

17. The system according to claim 16, wherein the rewards comprise a credit for a retail establishment, a credit for a treatment facility, or the delivery of free or reduced-fee content to the user's computing device.

18. The system according to claim 14, wherein the health content includes one or more treatment applications that are designed to improve the user's health condition or one or more configurations to be applied to the computing device to improve the user's health condition.

19. The system according to claim 18, wherein the health analysis engine is configured to dynamically manage the health content by causing the delivery of additional treatment applications to the computing device of the user, by causing the remote deletion of treatment applications from the computing device that have been deemed to be inappropriate or by causing the adjustment of the configurations to be applied to the computing device.

20. The system according to claim 14, further comprising an encryption engine that is configured to encrypt or decrypt the health information of the user and the health content for the user.
